(19) United States
(12) Patent Application Publication
(10) Pub. No.: US 2005/0022705 A1
(43) Pub. Date: Feb. 3, 2005

(54) Planting machine

(76) Inventor: Henry Copeland, Montgomery, AL (US)

Correspondence Address: WELSH & KATZ, LTD, 120 S RIVERSIDE PLAZA, 22ND FLOOR, CHICAGO, IL, 60606, US

(21) Appl. No.: 10/816,059

(22) Filed: Apr. 1, 2004

Related U.S. Application Data
(60) Provisional application No. 60/459,807, filed on Apr. 2, 2003.

(51) Int. Cl. A01C 11/00

(52) U.S. Cl. 111/100

(57) ABSTRACT

A planting machine for planting of seedlings into soil in a regular and uniform sequence, comprising a frame, at least one plant delivering unit comprising a means for conveying seedlings from a point of manual insertion to a point of placement in sequence in soil, each unit further comprising a means to open a furrow in soil, maintain opened furrow for delivery of seedling, and close opened furrow after delivery of seedling, said delivering unit having a rotatable drum, the structure of which defines compartments around its outermost surface for conveying seedlings from point of manual insertion to point of release, said drum compartments being outwardly open for reception of manually inserted seedlings and for release of seedlings to next delivery stage, further including; an upright conduit means, being open at its upper and lower ends and of sufficient size and located in proximity of, and exposed to, rotatable drum for acceptance of seedlings released from drum, such conduit means guiding seedling from point of release to point of delivery to furrow opening means.

### CROSS-REFERENCE TO RELATED APPLICATIONS

This application claims the benefit of U.S. Provisional Application Ser. No. 60/459,807, filed Apr. 2, 2003, which is herewith incorporated herein by reference.

### BACKGROUND

### FIELD

This invention relates in one embodiment to planting machines which are able to travel over the area of soil to be planted, open a furrow in the soil and continuously drop plants into the furrow. The furrow can then be immediately closed by the machine. An embodiment of this invention relates to the planting of plants which have developed in a nursery from seeds to a size which can be handled and can live in a farm field environment. Such plants are commonly referred to as “seedlings”. In devices such as mechanical tobacco and pine tree planting machines, the seedlings are typically manually inserted into mechanical hands which place them in an opened furrow. In devices such as manual planting machines, the operator typically places the seedlings directly in the opened furrow by hand. In either type of known device, the furrow can typically be closed by the machine.

At the present time, many seedling plants, such as onions are planted by persons who manually place each plant in an indentation in the soil, then close, or tamp the plant secure in the indentation with a pressing motion of the hand. The soil indentations are often created by a cylindrical drum, provided with spikes placed in rows, and projecting radially from the drum. Such a drum can be axially mounted for free rotation and towed along the plant bed behind a farm tractor, forming the indentations as it rolls. Planting personnel walk or crawl along the area to be planted, carrying a supply of plants in one hand, placing and covering plants with the other.

Because of physical proximity of the furrows required for optimum plant density per acre, the size and shape of the planting mechanisms, and the space required on the planter for operating personnel, existing mechanical seedling planters are sometimes restricted to one operator per row of plants. Each operator on such known devices will, by hand, select and remove plant seedlings from a storage bin and place one plant seedling at a time in a delivery mechanism, which will deposit it in the previously opened furrow.

Since tobacco and tree seedling plants are comparatively large, and spacing along the row is large relative to the size of the plant, planting mechanism and operators, these systems are adequate to produce acceptable levels of production. However, in other applications, such as onion planting, where plants are tiny and spacing is approximately four inches along the row, they have not proved to be usable.

Other known systems use plant seedlings which have been grown in individual cups or multi-compartment trays. The uniformity of this type of holder for the plant makes an easy job for the machine to select and handle an individual plant seedling. Disadvantages of this system are the high cost of the special growing and handling equipment required, the complex mechanism required to coordinate the position of the plant tray with relation to the planting mechanism as well as the volume of storage space required on the planting machine to hold an adequate supply of plants carried in these containers.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1A is a side view of one embodiment and also shows a farm tractor.

FIG. 1B is a side view of one embodiment and also shows a farm

FIG. 2 is a top view of a main frame.

FIG. 2A is a side view of a main frame.

FIG. 2B is a sectional view of a main frame.

FIG. 2C is a front view of a main frame.

FIG. 3 is a partial cross section of elements of a planting mechanism.

FIG. 4A is a top view of a planter drum.

FIG. 4B is a side view of a planter drum.

FIG. 4C is a front view of a planter drum.

FIG. 5 is a top cross-sectional view of a planter drum drive line.

FIG. 6 is a top view of a planter drum counter rotation drive.

FIG. 6A is a partial sectional view of a planter drum counter rotation drive.

FIG. 6B is a partial sectional view of a planter drum counter rotation drive.

FIG. 6C is a partial sectional view of a planter drum counter rotation drive.

FIG. 7 is a side view of a traction wheel travel stop.

FIG. 7A is a side view of a fender support post and keyhole cut-out.

FIG. 7B is a front view of a traction wheel travel stop.

FIG. 8 is a side view of a floating skid assembly.

FIG. 8A is a bottom view of a floating skid assembly.

FIG. 8B is a top view of a floating skid assembly.

FIG. 8C is a rear view of a floating skid assembly.

FIG. 8D is a cut-away view of an area of the floating skid frame of the skid belly.

FIG. 8D is a view of a planter plow.

FIG. 9 is a view of a of plant chute.

FIG. 9A is a cross-sectional view of a of plant chute.

FIG. 10 is a side of an air nozzle.

FIG. 10A is a cross-sectional view of an air nozzle.

FIG. 10 is a view of an air nozzle with air hose.

FIG. 11 is an air compressor drive line.

FIG. 11A is a side view of part of an air compressor drive line.

FIG. 12 is an air supply circuit.

### DETAILED DESCRIPTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated. It should be further understood that the title of this section of this specification, namely, “Detailed Description Of The Invention”, relates to a requirement of the United States Patent Office, and does not imply, nor should be inferred to limit the subject matter disclosed herein.

In the present disclosure, the words “a” or “an” are to be taken to include both the singular and the plural. Conversely, any reference to plural items shall, where appropriate, include the singular.

Referring to the drawings, an embodiment of the present invention, directed to a method and apparatus for manufacturing an aluminum MMC (Metal Matrix Composite) disk rotor, is now explained in detail.

Various embodiments of the invention can accomplish some or all of the following objects. An embodiment of this invention includes, for example, a planting machine which utilizes more than one operator per row of plants. Another embodiment includes, for example, a planting machine which will dispense seedling plants in a regular, uniformly spaced pattern, providing a desirable optimum growing space for each plant. Another embodiment includes, for example, a planting machine which will dispense seedling plants at a large number of plants per unit of travel, maintaining desirable close plant spacing. Another embodiment includes a planting machine which will dispense seedling plants at a high rate of plants per unit of time, maintaining a desirable high rate of production. Another embodiment includes, for example, a planting machine which will carry a supply of seedling plants in sufficient quantities to allow for optimum utilization of the planting machine in fields where rows are of great length and require many plants to fill. Another embodiment includes, for example, a planting machine which will be easily carried by the three point hitch system of a standard farm tractor and obtain all required operating power from the tractor. Another embodiment includes, for example, a planting machine which will shape the soil of the plant bed for optimum plant growth and production. Another embodiment includes, for example, a planting machine which will allow for easy adjustment of plant spacing along the row, to accommodate variations in mature plant size and growing practice. Another embodiment includes, for example, a planting machine which will plant at a higher rate of production when compared to existing planting methods. Another embodiment includes, for example, a planting machine which does not require special preparation of the seedlings, individual holding containers and large volume storage areas on the planting machine. Another embodiment includes, for example, a planting machine which will allow use of seedling plants packaged in bundles and packed in industry standard crates as is common practice in current manual planting operations. Another embodiment includes, for example, a planting machine in which the seedling dispensing mechanism will be driven by a traction wheel impelled by contact with the ground surface as the unit is moved over it. Those of skill in the art may recognize other and further objects, advantages, and embodiments of the invention from a consideration of the ensuing description and accompanying drawings. It is the applicants intent that such variations are encompassed within the scope of this disclosure and the claims below.

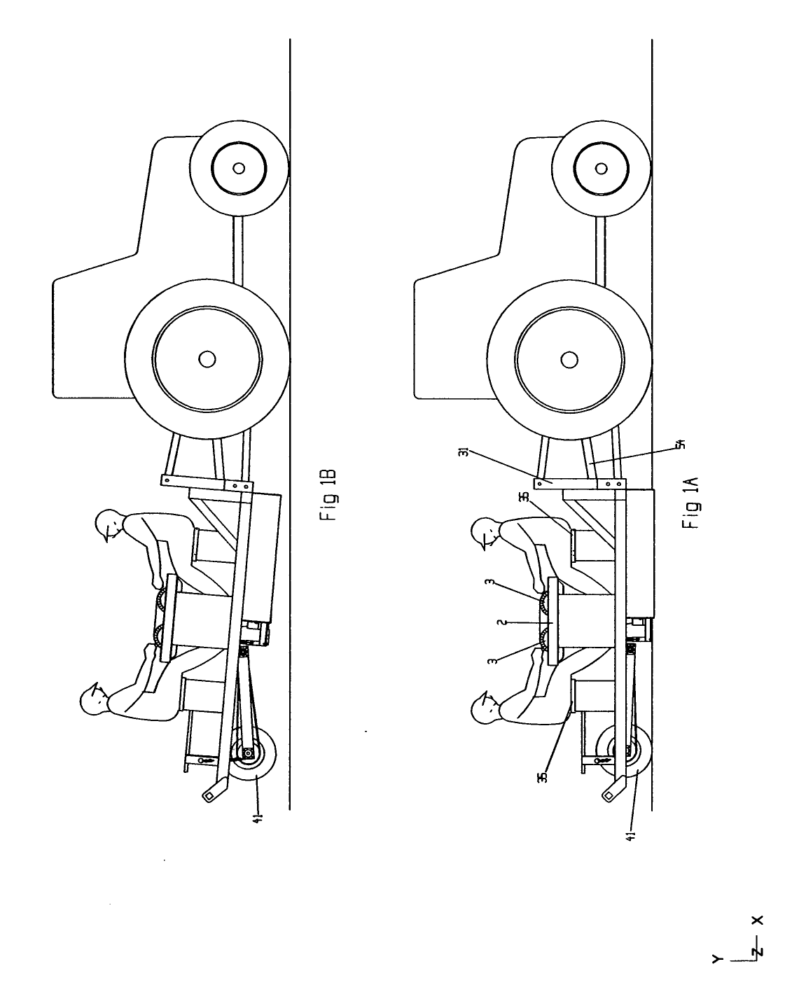

FIG. 1A illustrates planting machine 1 attached by three-point hitch frame 31 to a conventional farm tractor. Tractor power take off (PTO) shaft 54 connects planting machine air compressor drive to tractor PTO output shaft. Operators sit on seats 35 facing the planter console 2 from opposite sides. Four operators on opposite sides of console (eight operators total) are each positioned in front of, and in close proximity to a plant collecting and dispensing device, which in the case of one embodiment, is an axially mounted rotatable planter drum 3. A traction wheel 41 is shown in this embodiment operably connected to rotatable planter drum 3. FIG. 1A illustrates planting machine in planting position, with machine level and in contact with ground area to be planted. FIG. 1B illustrates planting machine in raised, travel position with all elements of machine clear of ground.

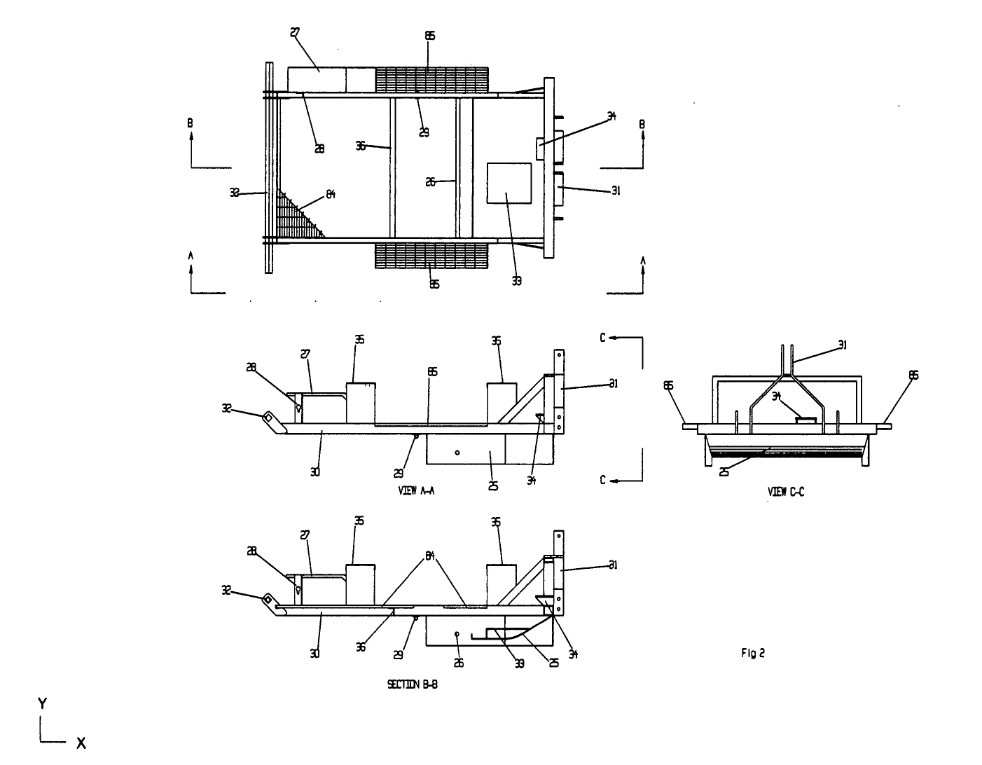

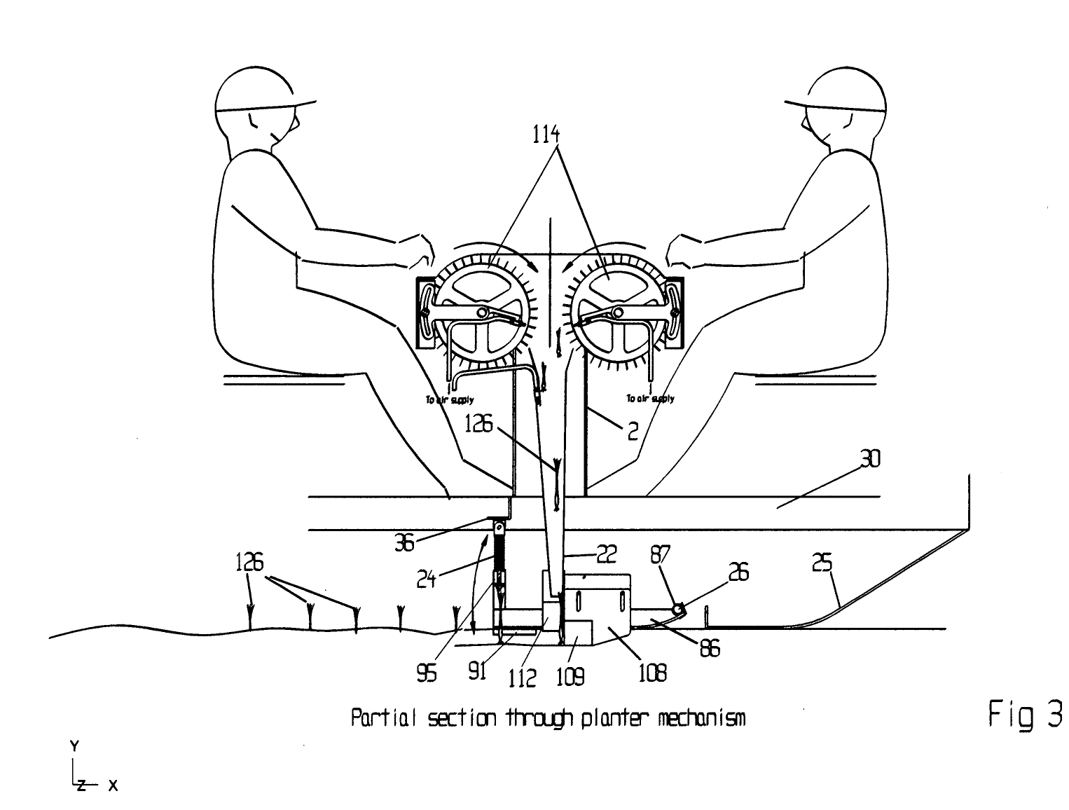

FIG. 2, FIG. 2A, FIG. 2B, and FIG. 2C illustrate planter mainframe as constructed in one embodiment. The mainframe comprises several welded steel elements, among them three-point hitch frame 31 and main frame rails 30. Main frame rails 30 are connected to each other by cross members 32 and 36, and the pan structure 25 shown in FIG. 2A, FIG. 2B, and FIG. 2C. Cross-member 32 in the embodiment shown in FIG. 2, FIG. 2A, and FIG. 2B is an elongated tube which extends beyond frame rails 30, to provide a mount structure for attachments associated with planting process, such as, for example, sweep plows and chemical spray equipment. Cross member 36 serves in the pictured embodiment as mounting structure for skid downforce spring 24 pictured in FIG. 3. Pan structure 25 is a sheet steel weldment comprising a ski shaped center section and two opposing side panels. Center section of pan structure 25 supports air compressor pump mount 33, both depicted in FIG. 2B. Other frame elements depicted in this embodiment include floorboards and plant storage area 84, running boards 85, and operator seats 35, fender 27 and support post 28.

FIG. 3 illustrates an arrangement of planting machine elements in one exemplary embodiment. Mechanism for planting one row of plants comprises in this embodiment opposing pairs of planter drums 114, chute 22, floating skid 86 with plant guide 112, furrow opening plow blade 108, furrow widening plow wedge 109, and furrow closing fins 91. Console 2 is securely attached to frame rails 30 in one embodiment by welding or other suitable means. Floating skid 86 in one embodiment is pivotally mounted on frame cross member 26 and forced against the earth by skid downforce spring 24, acting between frame cross member 36 and floating skid arch 45.

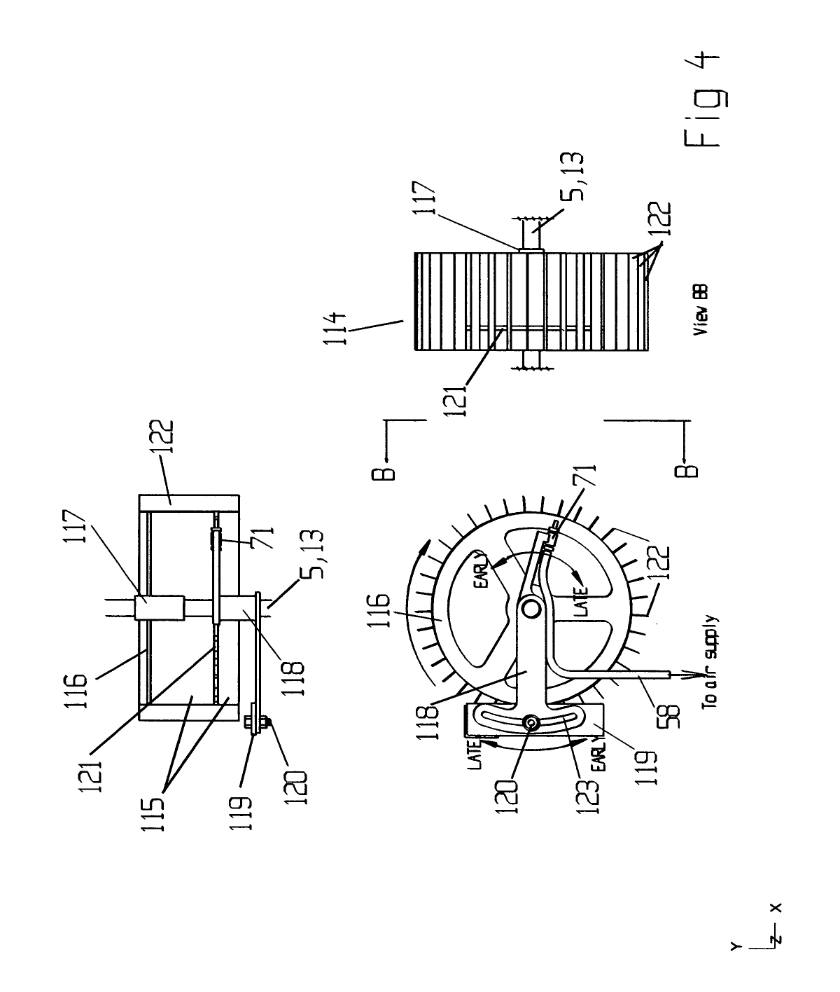

FIG. 4, FIG. 4A, and FIG. 4B illustrate planter drum 114 mechanism in one embodiment. Planter drum mechanism comprises a two-part cylindrical drum 115, spoked web 116, hub 117, plant carrier flights 122, together with air nozzle mount 118, air nozzle 71, and air supply hose 58. Air nozzle mount 118 is rotatably mounted on drum shaft 5,13 so that angle of air nozzle 71 relative to a level position is adjustable through range of travel of clamp plate 123, and is secured in place to frame bar 119 by lock bolt 120. Two parts of cylinder drum 115 are separated by a narrow circumferential slot 121. Slot 121 is provided for passage of air from nozzle 71 to plant carrier flights 122, and in the preferred embodiment, divides cylindrical drum 115 into two parts, longer part being approximately three-fourths of total length, shorter part being approximately one forth of total length. Two parts of cylindrical drum 115 are connected by multiple plant carrier flights 122, flights being secured to both cylinder parts by welding, bolting or other suitable means. Planter drum mechanism 114 is mounted on rotatable shaft 5, 13 and secured from rotation relative to shaft by keyway and setscrew or other acceptable means.

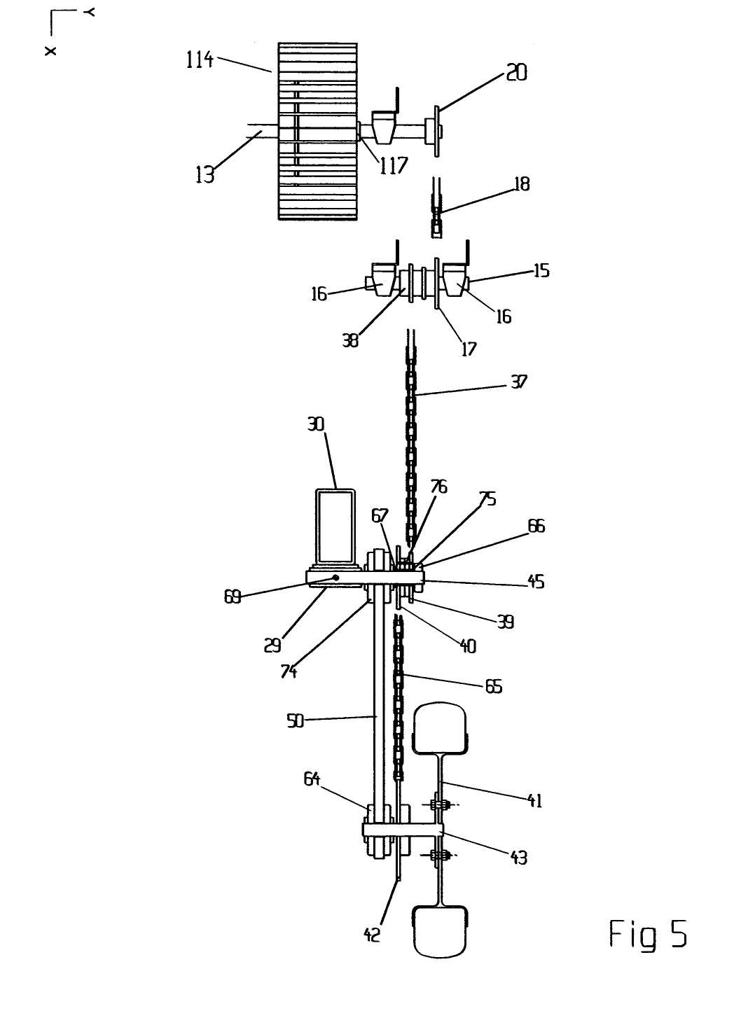

FIG. 5 illustrates drive line from traction wheel 41 to drum shaft 13 in one embodiment. Traction wheel 41 is removably mounted on axle 43 which is, in turn rotatably mounted in bearings 64. Bearings 64 are opposedly mounted on sides of traction wheel arm 50. Traction wheel arm 50 is, in turn pivotally mounted to mainframe rail 30 by mount 29, bearings 74 and axle 45. Bearings 74 are opposedly mounted on sides of arm 50. Axle 45 is mounted within hollow tubular body of mount 29 and secured and positioned by bolt 69 or other suitable means. Thus, traction arm 50, together with all components attached thereto, is mounted for rotation about axle 45 with said axle securely attached to mainframe rail 30.

Further with reference to an embodiment depicted in FIG. 5, sprocket 42 is attached to axle 43 and secured from rotation relative to axle by keyway and setscrew or other acceptable means. Other components including sprocket 39 and sprocket 40 and the planter drum wheel 14 are rotatably linked to sprocket 40 by drive chain 65. Sprocket 39 and sprocket 40 are mounted for rotation on axle 45, supported by shoulder sleeve bearing 67 and washer 75. Sprocket 39 and sprocket 40 are connected and prevented from rotation, one relative to the other, by drive pin 76 or other suitable means. Sprocket 39, sprocket 40, shoulder sleeve bearing 67 and washer 75 are retained on axle 45 by ring collar 66 which is secured in position by setscrew or other suitable means.

Further with reference to an embodiment depicted in FIG. 5, bearings 16 are securely mounted to table shelf frame 19 and support opposite ends of jackshaft 15. Sprocket 38 is mounted on jackshaft 15 and secured from rotation relative to shaft by keyway and setscrew or other acceptable means. Sprocket 38 is rotatably linked to sprocket 39 by chain 37. Sprocket 17 is mounted on shaft 15 and secured from rotation relative to shaft by keyway and setscrew or other acceptable means. Sprocket 17 is rotatably linked to sprocket 20 by chain 18. Sprocket 20 and planter drum 114 are mounted on shaft 13 and secured from rotation relative to shaft by keyway and setscrew or other acceptable means. Bearing 21 is securely mounted to table shelf frame 19 and supports one end of shaft 13. Thus, traction wheel 41 is, through axle 43, sprocket 42, chain 65, sprocket 40, drive pin 76, sprocket 39, chain 37, sprocket 38, jackshaft 15, sprocket 17, chain 18, sprocket 20, and shaft 13, linked for rotation to planter drum 114. Number of teeth in sprockets 42, 40, 39 and 38 determine final ratio of rotation between traction wheel 41 and drum 114.

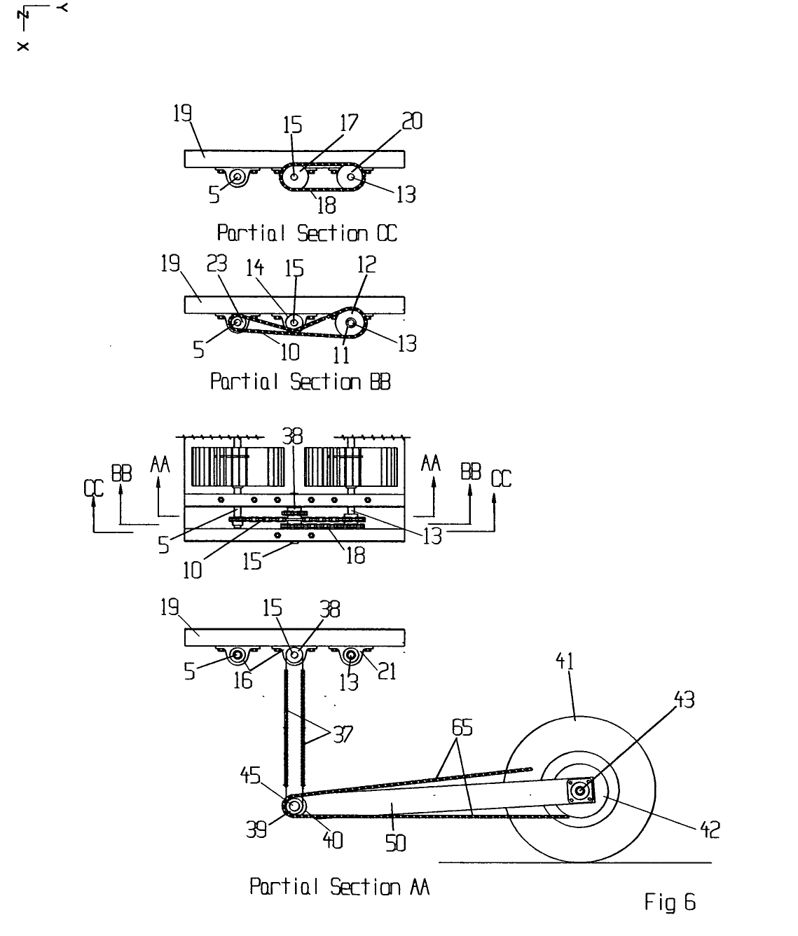

FIG. 6, FIG. 6A, FIG. 6B, and FIG. 6C illustrate system used in one embodiment to obtain required opposite directions of drum rotation. Many methods exist that could obtain the same result, and the invention is not limited to system employed in the pictured embodiment.

Partial section AA in FIG. 6A further illustrates elements also shown in FIG. 5 which rotatably link traction wheel 41 to jackshaft 15.

Partial section BB in FIG. 6B further illustrates rotation reversing system. In the embodiment depicted, sprocket 14, together with sprocket 17 and sprocket 38, is mounted on jackshaft 15 and secured from rotation relative to shaft by keyway and setscrew or other acceptable means. Idler sprocket 12 is mounted for free rotation on shaft 13 and supported on shaft by bushing 11. Sprocket 23 is mounted on shaft 5 and secured from rotation relative to shaft by keyway and setscrew or other acceptable means. Chain 10 is routed over sprocket 23 and idler sprocket 12, and under sprocket 14. Sprocket 23 and sprocket 14 in the illustrated embodiment have the same number of teeth.

Partial section CC in FIG. 6B further illustrates rotational linkage between jackshaft 15 and drum shaft 13. In the embodiment depicted, sprocket 17 is mounted on jackshaft 15 and secured from rotation relative to shaft by keyway and setscrew or other acceptable means. Sprocket 20 is mounted on drum shaft 13 and secured from rotation relative to shaft by keyway and setscrew or other acceptable means. Sprockets 17 and 20 have the same number of teeth and are linked for rotation by chain 18.

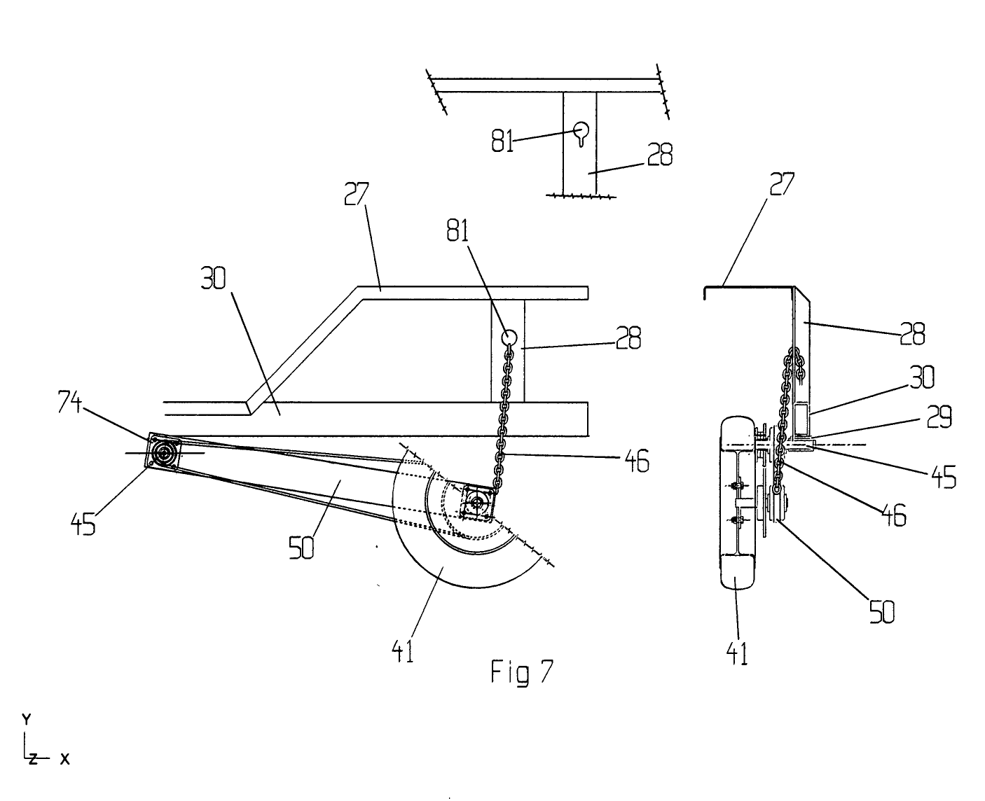

FIG. 7, FIG. 7A, and FIG. 7B illustrate in one embodiment traction wheel arm 50, which is pivotally mounted to mainframe rail 30 by mount 29, bearings 74 and axle 45. In the embodiment depicted, link chain 46 is securely attached to arm 50 by welding or other suitable means. Fender support post 28 is provided with keyhole cutout 81, cutout being of a diameter sufficiently large to allow easy passage of chain through it. Cutout is provided with connected slot of correct width and length to accept and retain single link of chain 46.

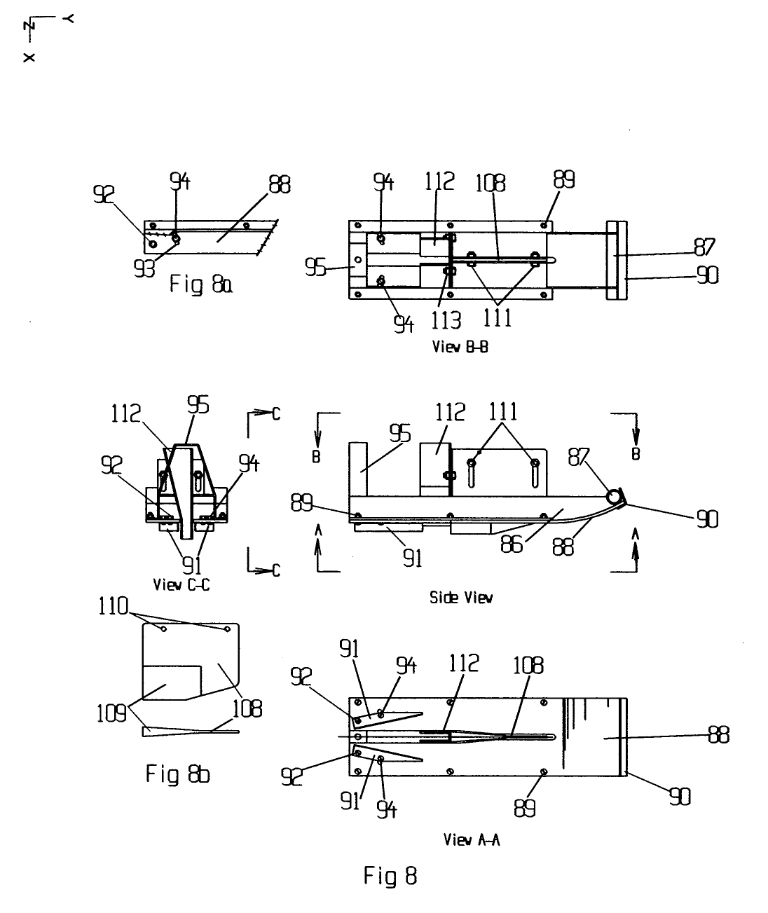

FIG. 8, FIG. 8A, FIG. 8B, FIG. 8C, FIG. 8D, and FIG. 8E illustrate in one embodiment a mechanism used to open a furrow in the earth to be planted, and to close the furrow thus opened and containing seedling plants. Floating skid frame 86, in the depicted embodiment, is constructed of welded metal or other suitable material and comprises an elongated body with tube 87 at forward end and arch 95 at trailing end. Tube 87 is provided for pivitable mounting to planter frame member. Skid belly 88 is constructed of abrasion resisting material and is attached to skid frame 86 through capture by retaining angle cross member 90 and mounting bolts 89, or other suitable means. Furrow closing fins 91 are constructed of abrasion resisting material and are adjustably and opposidly mounted to the bottom surface of skid belly 88. Furrow closing fin 91 is mounted for rotation about bolt 92, being secured in its adjusted position by bolt 94. Slot 93 in skid belly 88 is located concentric with center of bolt 92 and allows required range of angular adjustment for furrow closing fin 91. FIG. 8D is a cut-away view of the area of floating skid frame which exposes bolts 92 and 94.

Further with reference to the embodiment depicted in FIG. 8, FIG. 8A, FIG. 8B, FIG. 8C, FIG. 8D, and FIG. 8E, plant guide 112 is of a funnel shape and is adjustably mounted on skid frame 86 and retained in position by bolts 113. Plant guides 112 are, in the preferred embodiment, asymmetrical in construction, being offset away from the centerline of the machine for improved travel of the seedling plant into the open furrow.

Further with reference to the embodiment depicted FIG. 8E illustrates planter plow which, in the preferred embodiment, is constructed of abrasion resisting material and comprises blade 108, and wedge, 109. Wedge shape is attached to blade by welding or other suitable means. Blade is provided with holes 110 for adjustable mounting in skid frame 86, and is retained in position by bolts 111.

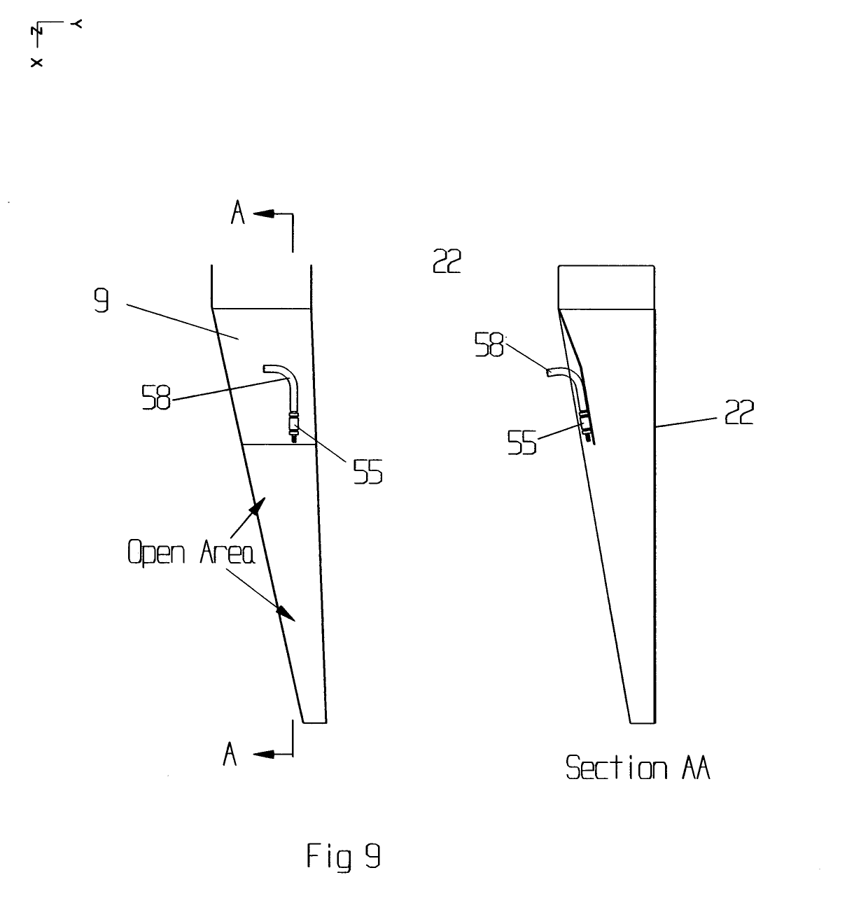

FIG. 9 and FIG. 9A illustrate in one embodiment chute 22, which in the depicted embodiment comprises an elongated, tapered hollow channel shell of rectangular cross section. In the depicted embodiment, a lengthwise portion of channel at broad end of taper comprises four joined sides, with remaining length of channel comprising three sides only. Air nozzle 55 is securely mounted on shortened fourth side 9 by welding, clamping or other acceptable means, with lengthwise axis of nozzle aligned with elongated axis of channel and with nozzle exit end directed toward narrow end of taper.

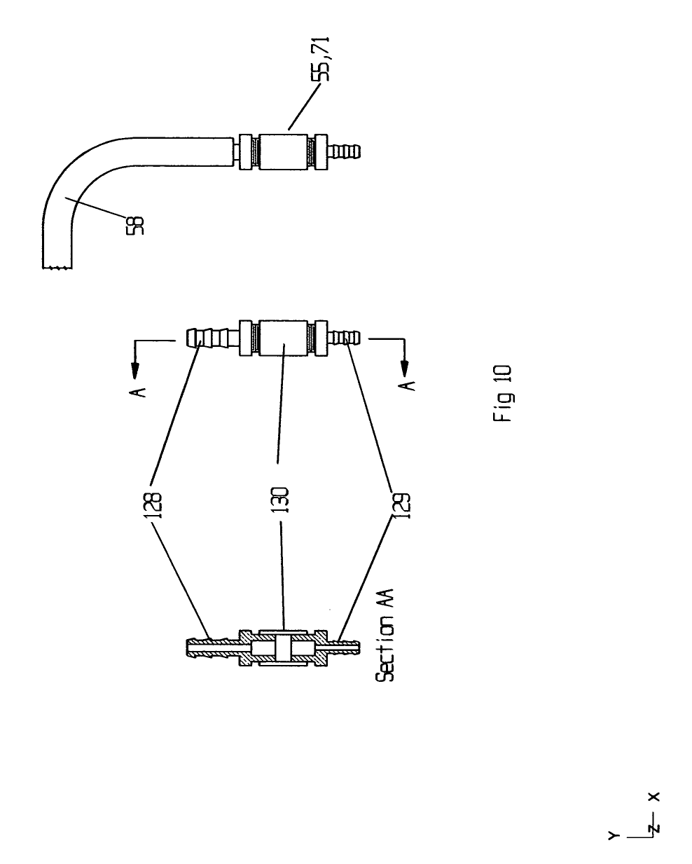

FIG. 10 and FIG. 10B illustrate in one embodiment construction of air nozzle 55 and air nozzle 71. In the embodiment depicted, sprag type push-on threaded hose fitting 128 of size matching hose 58 is threaded into one end of standard pipe coupling 130. Similar fitting 129, with matching thread size, is threaded into opposite end of coupling. Push-on sprag of fitting 129 which serves as flow-restricting nozzle. In the embodiment shown, push-on barb is sized for 1/8 inch hose, giving an exit orifice diameter of approximately 0.05 inches.

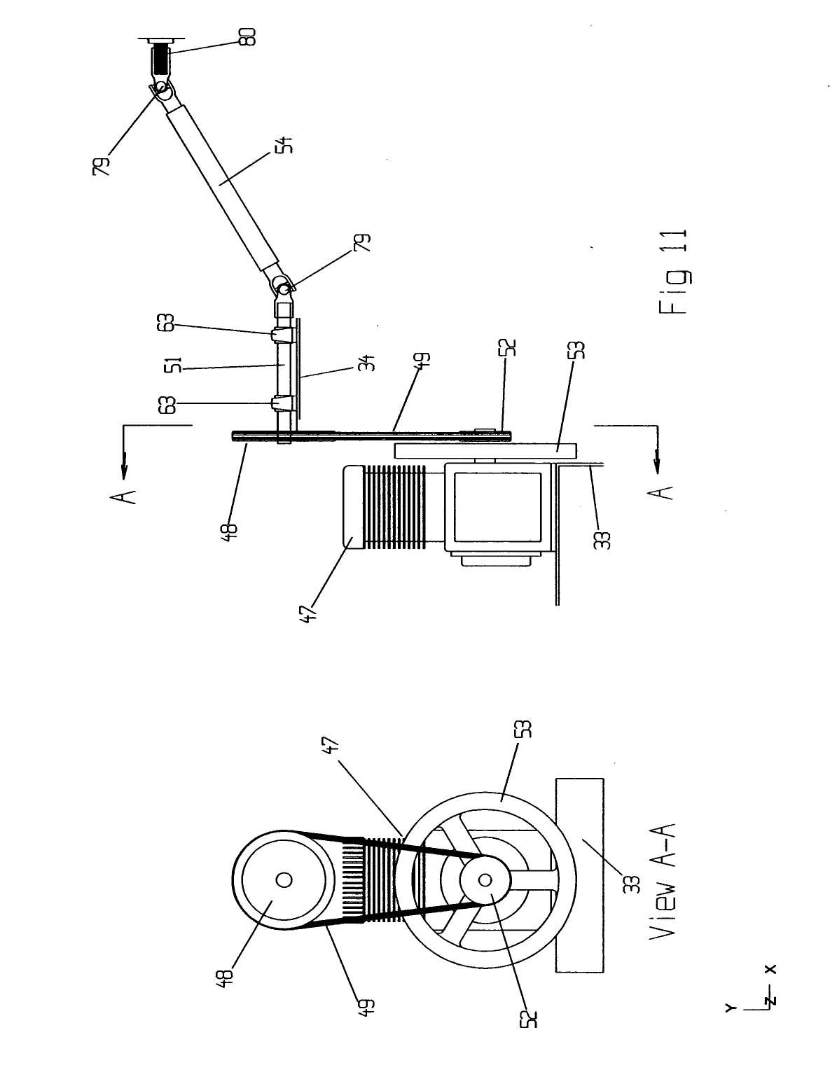

FIG. 11 and FIG. 11A illustrates in one embodiment drive line from tractor PTO shaft 80, to planter air compressor pump 47, as employed in the depicted embodiment. Universal joints 79 and shaft 54 is a common agricultural driveshaft assembly as commonly used on pieces of PTO driven farm machinery. Jackshaft 51 is retained and supported by bearings 63, located near opposite ends of the shaft. Bearings 63 are removably mounted to plate 34, which is a component of planter frame.

Further with reference to the embodiment depicted in FIG. 11 and FIG. 11A, driveshaft assembly is mounted on one end of jackshaft 51 and secured from rotation relative to shaft by keyway and setscrew or other acceptable means. Pulley 48 is mounted on end of jackshaft 51 opposite driveshaft assembly end. Pulley 52 is securely attached to pump flywheel 53 by bolts, welding or other suitable means. Pulley 48, belt 49 and pulley 52 comprise a means to transmit rotational power from jackshaft 51 to air compressor pump 47 at a desired speed of rotation relative to tractor PTO speed.

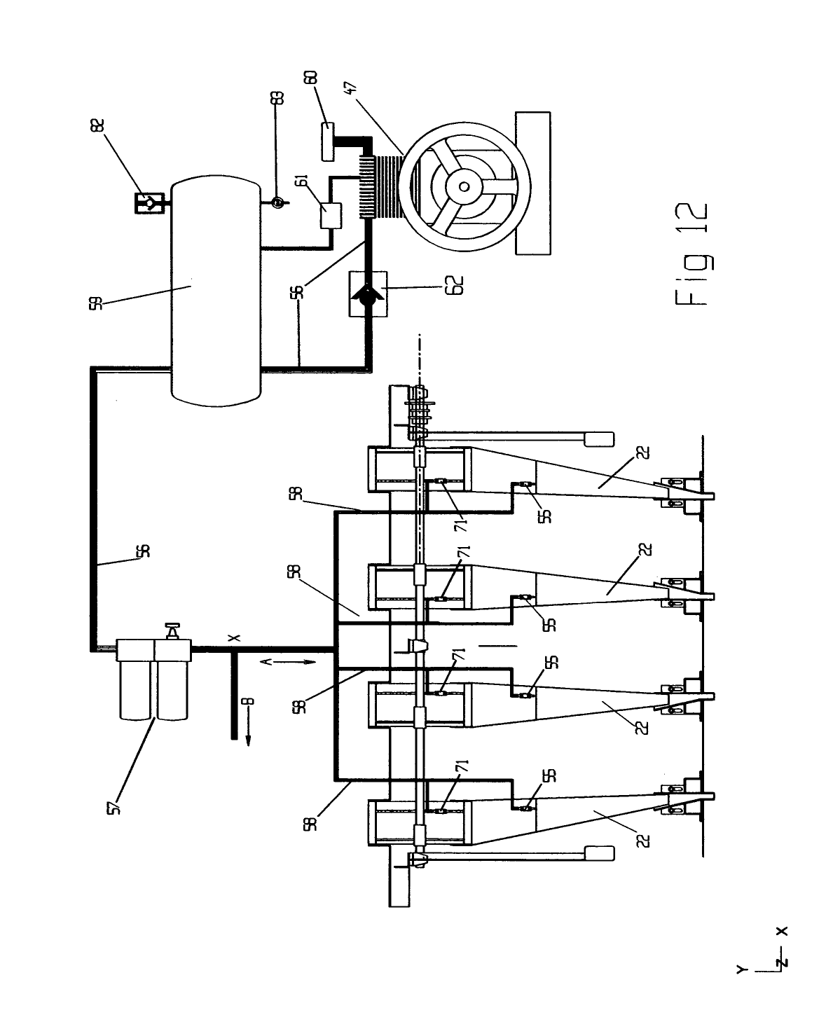

FIG. 12 illustrates planter air supply system as employed in the depicted embodiment. Tractor PTO driven air compressor pump 47 is connected by air hose 56 to check valve 62. Compressor pump 47 is provided with an unloading valve 61, which suspends pumping function when air pressure in storage tank 58 reaches a preset level. This action reduces heat buildup in compressor pump and provides for more efficient pump operation than would releasing excess high pressure air to the atmosphere. Check valve 62 is connected to air supply storage tank 59 by hose 56. Hose 56 in each instance is rubber push-on hose, connected to attached components by threaded sprag type fittings, or other suitable means. Air supply storage tank 59 is provided with air pressure safety release valve 82, and drain valve 83. Air supply storage tank 59 is connected to filter regulator set 57 by hose 56. Filter regulator set 57 is a standard commercial unit, of common use in industry. Using a standard tee fitting, hose 56 is divided at point “X” into two equal branches, “A” and “B”. Branch “A” supplies air to 4 planter drum and chute nozzles shown, while branch “B” supplies air to an additional set of 4 planter drum and chute nozzles of same design and construction as those shown. Hose 56 is divided at a point past point “X” into 4 branch hoses 58, each branch further divided to supply air to one drum nozzle 71, and one chute nozzle 56.

It will be appreciated by those of ordinary skill in the art that the air hose 56 can be any known or hereafter developed means for providing a blast of air or similar gas or liquid to facilitate planting of seedlings. Pneumatic or hydraulic devices of other kinds to produce jets of air or liquid can also be used for such a purpose and are considered within the scope of the invention.

With reference to the operation of one embodiment of the invention, FIG. 1A and FIG. 1B illustrate one embodiment of the planting machine 1 attached by three point hitch 31 to a standard farm tractor. Tractor power take off (PTO) shaft 54 connects planting machine air compressor drive to tractor PTO output shaft. Operators sit on seats 35 facing the planter console 2 from opposite sides. Four operators on two opposite sides of the console (eight operators total) are each positioned in front of, and in close proximity to a plant collecting and dispensing device, which in the case of the preferred embodiment, is an axially mounted rotatable planter drum 3. FIG. 1A illustrates planting machine in planting position, with machine level and in contact with ground area to be planted. For travel outside the planting operation, turning around at the end of a planting row and other non-planting operations, a tractor towing the depicted embodiment can use three point hitch 31 to raise planting machine clear of the planting surface as shown in FIG. 1B.

Further with reference to the operation of the embodiment depicted in FIG. 1, the planting machine 1 opens one or more furrows in soil to be planted, deposits seedling plants at regular spaced intervals, and closes opened furrow, securing planted seedling in a virtual upright position at correct planted depth for proper growth.

When the planting machine is lowered into correct position for contact with ground area to be planted as illustrated in FIG. 3 for one embodiment, skid 86, which comprises plow blade 108 and wedge 109 will be level with, and in solid contact with the soil area to be planted. As tractor moves planting machine over ground area to be planted, plow blade 108 opens furrow to the correct depth as determined by position of plow in skid frame 86. Furrow is widened to accept seedling plant by wedge 109.

Further with reference to the operation of the embodiment depicted in FIG. 3, each operator, positioned in front of a rotating planting drum 114, is furnished a supply of seedling plants stored in easy reach on the planting console 2. In the depicted embodiment, planting drum 114 is mounted inside console 2, with a small sector exposed to operator. As planting drum 114 rotates, empty flights 122 are exposed to operator, each flight rising from the console and moving away from the operator's position. Operator manually drops seedling plants into spaces between moving flights 122, with root end of plant positioned toward slot 121 end of planter drum.

Seedling plants in one embodiment are carried in planter drum to a position, as seen in FIG. 4, near air nozzle 71. Air nozzle 71 provides a constant blast of air directed through slot 121, and into space between flights 122. As seedling plant passes past air blast of nozzle 71 it is blown off flight 122 and is free to fall down chute 22. Root end of seedling plant is heavier and more dense than leaf end, causing plant to fall root end down as it is ejected from planter drum 114,

Further with reference to the operation of the embodiment depicted in FIG. 4, seedling plants are of inconsistent weight, density and shape among various species, crops, and growing areas, hence effect of air blast from nozzle 71 varies with different plant characteristics. To compensate for differences in effect of air blast, angular position of nozzle mount 118 with relation to position of plant to be ejected from drum can be adjusted for earlier or later ejection of plant from planter drum. Adjusted position is maintained by clamp plate 123 which is secured to frame bar 119 by lock bolt 120.

Although plants in the embodiment depicted will typically drop from planter flights without application of air blast, radial position of release point may be inconsistent and may vary greatly from plant to plant within the same plant group. With required spacing of 4 inches and travel speed of one foot per second, a slight variation in plant release point between to plants can cause great variation in plant spacing. Precise angular positioning of nozzle relative to plant to be ejected causes plant to be released to fall free at the same instant and position from one plant to the next.

As shown in FIG. 3, in one embodiment opposing planter drums which dispense plants into the same furrow are set up with flights one-half space out of time with relation to air nozzle 71. As one planting drum passes into nozzle air blast in the depicted embodiment, its opposing planter drum is positioned for one-half flight space delay to reach nozzle blast. This alternating ejection of plants from opposing planter drums results in even spacing of plants along planted row.

As illustrated in FIG. 9, in one embodiment the planting machine is provided with a plant chute 22 for each pair of opposing planter drums, with opposing drums alternately ejecting plants into the same chute. In applications where plant density along the planted row is less, only one planter drum, utilizing the same features and elements set forth here, may be required to meet planting rate needs. Chute 22 is provided with full length sides on three surfaces and a shortened side on one surface. In cases where plants will occasionally clump together during travel from ejection from planter drum to position in open furrow, open side of chute will allow plant clump to fall free from chute without congesting chute and disrupting planting operation. In order to maintain travel path of a plant away from open side of chute and to accelerate plant toward furrow, an air nozzle 55, is positioned on shortened side of chute 9, with its air flow directed toward furrow. Nozzle 55 air flow forces falling plant to move toward opposite of chute. Air flow from nozzle 55 is not adequate to force a clump of plants to opposite wall, so clump will fall free and out of open side of chute. Free falling seedling plants fall at varying rates depending on plant characteristics of weight and aerodynamic drag of the leafy end of plant, a leafy, light weight, plant falling more slowly than a relatively heavy plant with few leaves. When propelled by air flow of nozzle 55, plants tend to travel at a more uniform rate, with light, leafy plants being accelerated by air flow to a greater degree than relatively heavy plants with few leaves. This equalization of travel speeds results in a more uniform spacing of plants along planted row.

With reference to FIG. 3 and FIG. 8, in one embodiment plants move from chute 22 to plant guide 112, which directs plant into open furrow. In order for plant to be captured by soil in proper, erect position, furrow must close around plant at correct instant. Plant guide 112 is adjustably mounted on skid frame 86 for positioning at various depths relative to the open furrow. Closing of the open furrow on plant is controlled by depth of plant guide 112 relative to open furrow. As plant guide 112 is lowered into furrow closing of furrow is delayed by interposing side walls of plant guide. As position of plant guide 112 is raised relative to furrow, less area of side walls is interposed between plant and closing furrow. Adjustability of planting guide 112 depth allows planter to compensate for various soil conditions, with guide being raised for dense, stiff soils and lowered for sandy, soft soils.

As shown in an embodiment depicted in FIG. 3, Skid 86 is pivotally mounted on frame cross member 26, a round rod of correct diameter to allow free rotation of tube 87. Spring 24 applies downward force on arch 95 and hence to skid 86. Skid belly 88 slides along soil of planting area, and due to downward force of spring 24 and pivotal mounting on cross member 26, maintains constant contact as soil level rises or falls with relation to planting machine.

As shown in an embodiment depicted in FIG. 8, skid 86 is provided with opposedly mounted furrow closing fins 91. It is the purpose of fins 91 to further compact the soil as it captures plant and return soil displaced by plow blade 108 and wedge 109 to the furrow. Fins 91 project downward into soil and converge relative to each other at trailing ends. As skid moves along furrow, converging arrangement of fins 92 scrapes displaced soil back into furrow and together with smoothing and compacting action of skid belly 88, further compacts soil around plants.

Planter drum 114 is driven in rotation by a series of chain linkages from traction wheel 41. Traction wheel 41 together with arm 50 is pivotably mounted on axle 45 with sufficient unrestricted travel to allow full contact of wheel with ground when planter is lowered into planting position. Traction wheel 41 together with arm 50 is attached to planter frame rail 30 by mount 29. Weight of Traction wheel 41, arm 50, and attached components such as chain drive, generates sufficient downward force to drive traction wheel in rotation as planter is moved over the area to be planted. As illustrated in FIG. 7, traction wheel is limited in downward travel by chain 46. Downward travel limit is set by adjusting length of chain between arm 50 and keyhole 81. Chain is adjusted for required up and down movement of traction wheel 41 during planting process and sufficient ground clearance while in a raised position, as shown for one embodiment in FIG. 1.

Spacing of plants along row in one embodiment is determined by relation of distance traveled by traction wheel 41 and number of flights 122 moving past air nozzle 71. By way of example, in one embodiment the distance traveled in one rotation of traction wheel is 60 inches, the drive ratio between traction wheel and planter drum is 1:1, and the number of flights on drum is 20. In this example, 20 plants would be planted in 60 inches of travel, giving a plant spacing of 3 inches. By changing number of teeth on one or more drive sprockets in drive chain from traction wheel 41 to jackshaft 15, any desired ratio, and hence any plant spacing along the row, may be obtained.

FIG. 6, FIG. 6A, FIG. 6B, and FIG. 6C illustrate in one embodiment a system used in the preferred embodiment to obtain required opposite directions of drum rotation. Many methods exist that could obtain the same result, and the invention is not limited to system employed in the preferred embodiment.

FIG. 6A, illustrates in one embodiment elements also shown in FIG. 5 which rotatably link traction wheel 41 to jackshaft 15. All changes in drive ratio to alter spacing of plants along planted row must be undertaken between sprockets 42 and 40, and between sprockets 39 and 38.

Partial section FIG. 6B illustrates in one embodiment rotation reversing system. In the depicted embodiment, sprocket 14, together with sprocket 17 and sprocket 38, is mounted on jackshaft 15. Idler sprocket 12 is free to rotate on shaft 13. Sprocket 23 is rigidly mounted on shaft 5. Chain 10 is routed over sprocket 23 and idler sprocket 12, and under sprocket 14. Sprocket 23 and sprocket 14 have the same number of teeth. As jackshaft 15 is driven in a counter-clockwise rotation, sprocket 23 and hence shaft 5 will be driven in a clockwise rotation. To maintain coordinated rotation between opposing planter drums, sprockets 23 and 14 must have the same number of teeth.

Partial section FIG. 6C illustrates in one embodiment rotational linkage between jackshaft 15 and drum shaft 13. Sprocket 17 is rigidly mounted on jackshaft 15. Sprocket 20 is rigidly mounted on drum shaft 13. Sprockets 17 and 20 are linked for rotation by chain 18. To maintain coordinated rotation between opposing planter drums, sprockets 17 and 20 must have the same number of teeth.

Planter is provided in one embodiment with pressure air system as illustrated in FIG. 12. In the embodiment depicted, air compressor pump 47 provides supply of compressed air to operate drum nozzles 71 and chute nozzles 55. Air compressor pump is provided with unloading valve 61, which relieves pressure pumping load and circulates free air through the pump for cooling. Unloading valve 61 is operated when pressure in air tank 59 reaches a pre-set value. In one embodiment pump is active 75% of time and in non-pumping cooling mode 25%. Check valve 62 holds tank pressure when unloading valve operates, and relieves start-up load on pump when tank is at high pressure. Filter regulator set 57 is common commercial unit as found in industry. Filter guards against clogged nozzles and regulator reduces pressure from 100-125 p.s.i. air tank 59 pressure to 30-40 p.s.i. nozzle working pressure. Air system branches in one embodiment at point “X” on FIG. 12 to furnish air to similar set of planter drum and chute nozzles as those shown. Tank is provided with safety relief valve 82 which operates in case unloading valve fails and tank pressure reaches unsafe levels. A water drain valve 83, is installed at low point of air tank.

Air compressor pump in one embodiment is driven by carrying tractor's PTO output. Drive in one embodiment is illustrated in FIG. 11. Depending on tractor's PTO speed, either 550 or 1000 r.p.m, the size of pulleys 48 and 52 are selected in one embodiment to provide a pump operating speed of 1200 to 1500 r.p.m. with tractor engine at planting travel speed.

From the foregoing it will be observed that numerous modifications and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A planting machine for planting of seedlings into soil in a regular and uniform sequence, comprising:
a frame;
at least one plant delivering unit comprising a means for conveying seedlings from a point of manual insertion to a point of placement in sequence in soil, each unit further comprising a means to open a furrow in soil, maintain opened furrow for delivery of seedling, and close opened furrow after delivery of seedling, said delivering unit having a rotatable drum, the structure of which defines compartments around its outermost surface for conveying seedlings from point of manual insertion to point of release, said drum compartments being outwardly open for reception of manually inserted seedlings and for release of seedlings to next delivery stage, further including;
an upright conduit means, being open at its upper and lower ends and of sufficient size and located in proximity of, and exposed to, rotatable drum for acceptance of seedlings released from drum, such conduit means guiding seedling from point of release to point of delivery to furrow opening means.

2. A planting machine as claimed in claim 1, wherein said rotatable drum has a central shaft, being mounted at the end of said drum for rotation about its lengthwise axis, compartments in said drum being defined as the space between adjacent plates mounted for rotation on outer surface of said drum.

3. A planting machine as claimed in claim 1, wherein a means is provided to augment the release of seedling from rotatable drum at a predetermined point in its rotation with relation to upright conduit means, such augmenting means being a blast of pressurized air, such blast being delivered through an air restricting and directing means.

4. A planting machine as claimed in claim 3, wherein the predetermined point of augmentation of seedling release by air blast can be changed with relation upright conduit means, such change being effected by manual repositioning of air restricting and directing means.

5. A planting machine as claimed in claim 1, wherein the upright conduit means is of rectangular cross section, a portion of one side of said rectangle being open and unrestrictive to the flow of particles

6. A seedling planter, comprising:
a plant delivering unit,
a rotatable drum mounted on said plant delivering unit, said rotatable drum having compartments for conveying seedlings from point of insertion to point of release;
an jet associated with said rotatable drum, said jet facilitating even release of seedlings at said point of release.

7. A seedling planter according to claim 6, further comprising a from, wherein said plant delivering unit is mounted on said frame.

8. A seedling planter according to claim 7 wherein said frame is suitable for being pulled behind a tractor.

9. A seedling planter according to claim 7 further comprising a traction wheel, said traction wheel being mounted on said frame, said traction wheel being operable interconnected with said plant delivering unit to drive said plant delivering unit.

10. A method for planting seedlings, comprising:
inserting seedlings into a rotatable drum at a point of insertion;
conveying the seedlings to a point of release;
releasing the seedlings at the point of release for planting;
facilitating release of the seedlings at the point of release by a jet.

11. The method according to claim 10 wherein said jet is a jet of air from a nozzle.

12. The method according to claim 10 wherein the rotatable drum conveys the seedlings to the point of release
